(19) United States
(12) Patent Application Publication
(10) Pub. No.: US 2023/0337841 A1
(43) Pub. Date: Oct. 26, 2023

(54) RESILIENT PILLOW

(71) Applicant: BEARABY INC., Wilmington, DE (US)

(72) Inventor: Kathrin Hamm, New York, NY (US)

(73) Assignee: BEARABY INC., Wilmington, DE (US)

(21) Appl. No.: 18/304,727

(22) Filed: Apr. 21, 2023

Related U.S. Application Data
(60) Provisional application No. 63/363,421, filed on Apr. 22, 2022.

(51) Int. Cl. A47G 9/10

(52) U.S. Cl. CPC A47G 9/10; A47G 2009/1018

(57) ABSTRACT

Embodiments relate to a pillow formed of interlooped yarn, where the interlooped yarn is formed with an outer tube that encases a resilient inner material. The resilient inner material has an equilibrium free-standing shape and is compressible and configured to return to the equilibrium free-standing shape after compression. The yarn can be formed into the pillow (such as, e.g., via knotting) such that the pillow is resilient. More specifically, the pillow may be compressed by the user and will return to its original shape.

### CROSS-REFERENCE TO RELATED APPLICATIONS

This application claims the benefit of U.S. Provisional Application 63/363,421, filed Apr. 22, 2022, the entire contents of which is incorporated herein by reference.

### FIELD OF INVENTION

This disclosure is directed generally to a resilient yarn and a resilient pillow made from same.

### BRIEF SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Some embodiments relate to a pillow formed of interlooped yarn, where the interlooped yarn is formed with an outer tube that encases a resilient inner material. The resilient inner material has an equilibrium free-standing shape and is compressible and configured to return to the equilibrium free-standing shape after compression.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a perspective view of an embodiment of a resilient pillow formed with a yarn.

FIG. 2 is a side view of a yarn that can be used to construct the resilient pillow of FIG. 1.

FIG. 3 is a perspective view of a yarn that can be used to construct the resilient pillow of FIG. 1.

FIG. 4 is another perspective view of a yarn that can be used to construct the resilient pillow of FIG. 1.

FIG. 5 is a perspective view of another embodiment of a resilient pillow formed with a yarn.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. The exemplary embodiments described herein, however, are not intended to be limited to the particular forms disclosed. Rather, the instant disclosure covers all modifications, equivalents, and alternatives falling within the scope of the appended claims.

### DETAILED DESCRIPTION

The present disclosure is generally directed to a pillow formed with a resilient yarn so as to render the pillow resilient. “Resilient” as used herein refers to the ability of the yarn (and thus the pillow) to resume its original shape after compression.

The pillow may be designed for different end uses. In some embodiments, the pillow may be a decorative item designed for home decor or a toy designed to entertain. However, in other embodiments the pillow is of a weight sufficient to effectuate deep tissue pressure therapy and/or provide a person with therapeutic sensory and stress relief

As used herein, the terms “providing deep pressure therapy,” “bringing about deep pressure therapy” or “effectuating deep pressure therapy” and those similar thereto, refer to effectively causing deep pressure therapy (also known as deep pressure stimulation, deep touch pressure, etc.) in a person as herein described. More particularly, the terms “providing deep pressure therapy,” “bringing about deep pressure therapy” or “effectuating deep pressure therapy” and those similar thereto, refer to physically contacting an individual to effectively cause the individual's nervous system activity to switch from being dominated by their sympathetic nervous system to being dominated by their parasympathetic nervous system.

An individual's autonomic nervous system (ANS) receives information from the individual's body and environment, and in response thereto, sends signals out to regulate the individual's body and organs. The ANS includes the sympathetic and parasympathetic systems, which work together to help the individual physiologically respond in accordance with the information the ANS receives.

The sympathetic nervous system is often referred to as the “alert” or “fight or flight” response that is elicited during stressful or emergency situations. The parasympathetic nervous system, on the other hand, is responsible for regulating involuntary functions, such as heart rate and blood pressure, and stimulating the digestive tract. It brings a sense of calm and peace to the mind and body. When the parasympathetic nervous system takes over, an individual's heart rate slows, muscles relax, and circulation improves. When deep pressure is correctly applied, it relaxes the nervous system, causing the body to switch from running its sympathetic nervous system to its parasympathetic nervous system.

Deep touch pressure may also alter the person's hormone levels by decreasing their level of cortisol (which causes stress and anxiety) while increasing their levels of serotonin and dopamine (which help with mood regulation and relaxation).

The pillows disclosed here may provide a person with tactile sensory input, which provides proprioceptive input to the individual's body. The pillows can be configured such that, when they are placed on top of a user's lap, leg, arms, chest, etc., they bring about deep pressure therapy, thus causing the individual's parasympathetic system to increase and their sympathetic system to decrease. This may contribute to reducing a user's stress and anxiety. The pillows may also be configured such that they may be rolled on a body part of a user, or a user may roll a body part on the pillow, to effectuate a massaging effect on those body parts and/or reflex zones to assist in relaxing and reducing pain of the user. The pillows may also serve as a fidget toy that may be squeezed, hugged, poked, probed, etc. to keep anxious hands of a user busy and/or reduce or relieve tension and stress.

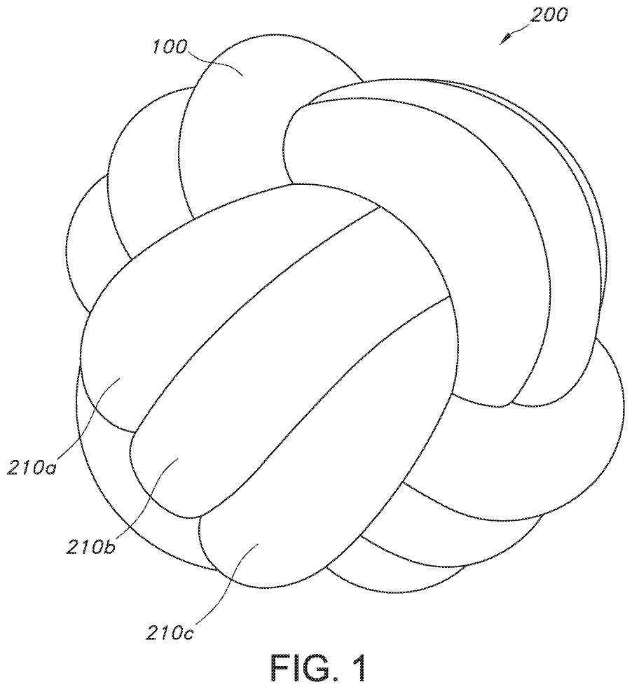

FIG. 1 is a perspective view of one embodiment of a resilient pillow 200 formed with a yarn 100 that is interlooped (e.g., knitted, crocheted, knotted, etc.) to form the pillow. More specifically, FIG. 1 shows an embodiment of a resilient pillow 200 that is constructed by interlooping yarn 100 using a knotting technique. Additionally or alternatively, other suitable techniques of interlooping the yarn 100 (e.g., crocheting, looping, knitting, etc.) may be implemented to form the resilient pillow 200 while remaining within the scope of this invention.

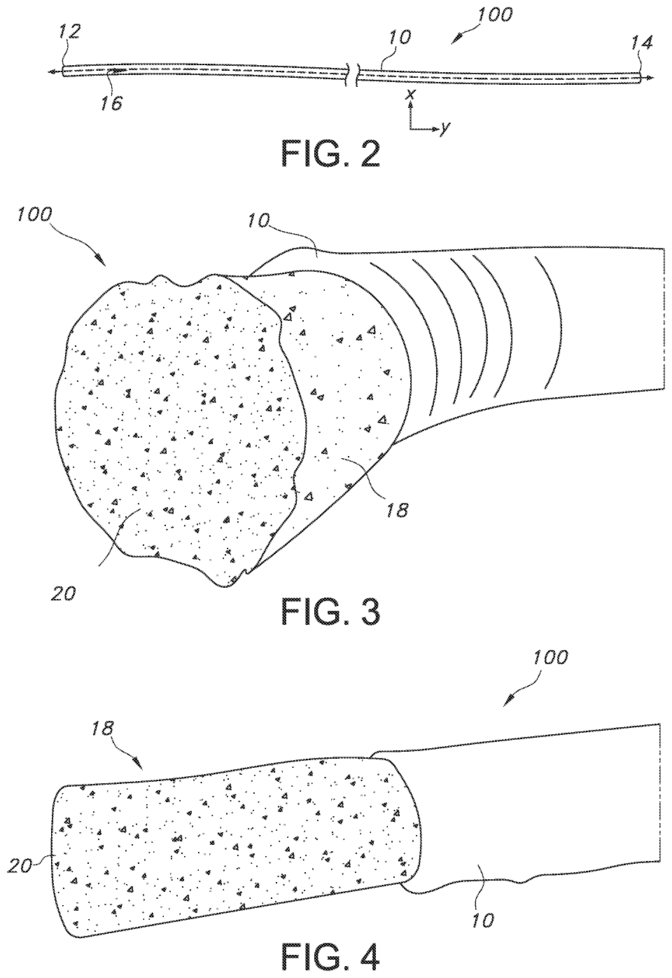

As seen schematically in FIG. 2, the yarn 100 includes an outer tube 10 that defines a conduit 16 extending longitudinally therethrough, from a first end 12 to a second end 14. An inner material 18 is provided in the conduit 16 and extends longitudinally from the first end 12 to the second end 14.

The construction of the yarn 100 may be, but does not have to be, the same or similar to that disclosed in U.S. Pat. No. 10,835,708, issued on Nov. 17, 2020 and entitled “Layered Yarn and Weighted Blanket for Deep Pressure Therapy,” U.S. Pat. No. 11,260,199, issued on Mar. 1, 2022 and entitled “Layered Yarn and Weighted Blanket for Deep Pressure Therapy,” and U.S. Patent Application No. 63/274,236, filed on Nov. 1, 2021 and entitled “Layered Yarn and Weighted Blanket for Deep Pressure Therapy,” the entirety of each of which is herein incorporated by this reference.

### Outer Tube 10

The outer tube 10 may be formed of any suitable fabric material or textile, such as, but not limited to a woven, knitted, nonwoven, fleece, velvet, linen, etc. fabric. The fabric may be formed of any suitable material or blends thereof, including, but not limited to, natural or synthetic cellulosic fibers (e.g., cotton such as organic cotton), wool fibers, elastane (e.g., Spandex or Lycra) fibers, polyester fibers, silk fibers, nylon fibers, flax fibers, bamboo fibers, coconut fibers, etc. In some embodiments, the fiber material is formed into yarns that are woven or knitted to form a fabric used to construct the outer tube 10. The fabric may be formed into the outer tube 10 to define the conduit 16. In some embodiments, the outer tube 10 is formed by rolling the fabric and securing it at a seam into a tubular shape. In other embodiments, the outer tube 10 is formed as a seamless tubular structure (e.g., such as via circular knitting). In some embodiments, the fabric forming the outer tube 10 is a substantially solid sheet of material such that the resulting outer tube 10 forms an outer sheath or encasement over the inner material 18 such that the inner material 18 is substantially or entirely invisible on the yarn 100.

In one non-limiting embodiment, the outer tube 10 is formed of a woven or knitted fabric formed of 100% natural materials (such as, but not limited to, cotton). In some embodiments, the fabric of the outer tube 10 and the materials from which it is made may be selected to impart stretch properties to the outer tube 10 that may facilitate later manipulation (e.g., knitting, knotting, etc.) of the yarn 100. For example, in another non-limiting example, the outer tube 10 is formed of a woven or knitted fabric formed of a blend of cotton and spandex (e.g., 95% cotton and 5% spandex).

The outer tube 10 may have a weight (i.e., area density) between approximately 60 and 240 grams/meter² (g/m²) inclusive, such as between approximately 80 g/m² and 220 g/m², inclusive; between approximately 100 g/m² and 200 g/m², inclusive; between approximately 120 g/m² and 200 g/m², inclusive; between approximately 140 g/m² and 200 g/m², inclusive; between approximately 160 g/m² and 200 g/m², inclusive; and between approximately 170 g/m² and 190 g/m², inclusive. In some embodiments, the outer tube 10 weighs approximately 160 g/m² or 180 g/m².

### Inner Material 18

The inner material 18 may be any material designed to impart sufficient weight and resiliency to the pillow 200. More specifically, in some embodiments the inner material 18 is one that may be compressed or deformed under pressure but that will substantially or entirely return to its original shape when the pressure is removed. In some embodiments, the inner material 18 is “structured” in that it may be formed into a free-standing shape that retains its shape without the need for the outer tube 10. For example, in some embodiments the inner material 18 is a foam material (e.g., charcoal foam, closed cell foam, open cell foam, high density foam, high resilience foam, rubber or latex foam, polyester foam, viscoelastic foam, etc.), a gel material (e.g., such as an elastomeric gel, a thermoplastic gel, etc.), or a rubber material (foamed or unfoamed). In one, non-limiting example, the inner material 18 is formed of an open cell latex rubber foam material, e.g., Melofoam™. It may be preferable in some embodiments to use an inner material 18 in the yarn 100 that is resilient and able to withstand elastic deformation without deforming plastically. It may also be preferable that the inner material 18 require a compression force that is sufficiently high to result in therapeutic benefits to the user when the pillow 200 is compressed.

Inner material 18 with a volumetric density ranging from approximately 30 kg/m³ to 160 kg/m³, inclusive, such as from approximately 30 kg/m³ to 90 kg/m³, inclusive, or from approximately 40 kg/m³ to 160 kg/m³, inclusive, may be particularly suitable in applications contemplated herein. In some embodiments, the inner material has a density range from approximately 30 kg/m³ to 80 kg/m³, inclusive; from approximately 40 kg/m³ to 80 kg/m³, inclusive; from approximately 40 kg/m³ to 70 kg/m³, inclusive; from approximately 50 kg/m³ to 60 kg/m³, inclusive; from approximately 60 kg/m³ to 65 kg/m³, inclusive; from approximately 60 kg/m³ to 70 kg/m³, inclusive; from approximately 50 kg/m³ to 70 kg/m³, inclusive; from approximately 50 kg/m³ to 160 kg/m³, inclusive; from approximately 60 kg/m³ to 140 kg/m³, inclusive; from approximately 70 kg/m³ to 120 kg/m³, inclusive; from approximately 80 kg/m³ to 100 kg/m³, inclusive; or from approximately 90 kg/m³ to 100 kg/m³, inclusive. In some embodiments, the inner material 18 density is over 40 kg/m³, over 50 kg/m³, over 60 kg/m³, over 70 kg/m³, over 80 kg/m³, and over 90 kg/m³.

The inner material 18 may be formed into the desired shape for insertion into outer tube 10. In some embodiments, the inner material 18 has a cross-sectional shape that is substantially the same as the cross-sectional shape of the yarn 100. While the inner material 18 and yarn 100 are shown as having a substantially circular cross-sectional shape, other cross-sectional shapes are contemplated, including, but not limited to, square, rectangular, triangular, ovular, etc.

In one embodiment, and as illustrated in FIGS. 3 and 4, the inner material 18 provided within the outer tube 10 is in the form of a foam tube 20 (such as, but not limited to, a foam rubber tube). Note that a length of the foam tube 20 has been pulled from the outer tube 10 for illustrative purposes only and demonstrates the structured nature of the inner material 18. The foam tube 20 may be formed by molding and steaming the material into the desired shape.

### Yarn 100

The yarn 100 is constructed by inserting the inner material 18 (such as, but not limited to, the open cell latex rubber foam tube 20) into the outer tube 10 such that the inner material 18 is encased within the outer tube 10. The inner material 18 may be disposed within the conduit 16 of the outer tube 10 so as to fill the volume of the conduit 16 by any suitable proportion (including up to 100%). In some embodiments, the inner material 18 occupies between about 75-99% of the volume of the conduit 16 or about 85-95% of the volume of the conduit 16. In some embodiments, the inner material 18 occupies substantially 100% of the volume of the conduit 16. The volume of the conduit 16 that the inner material 18 occupies may be selected to control the resulting weight of the yarn 100. The yarn 100 may be configured to have and maintain a substantially homogenous weight and density along its longitudinal length, even after formation into, and during use of, the resilient pillow 200.

The yarn 100 may have any suitable dimensions to be interlooped to form the resilient pillow 200. For example, the yarn 100 may have a length between approximately 1 meter (m) and 15 m, inclusive; between approximately 1.45 m and 1.55 m (e.g., 1.5 m), inclusive; between approximately 4.25 m and 4.45 m (e.g., 4.35 m), inclusive; between approximately 5.9 m and 6.1 m (e.g., 6 m), inclusive; between approximately 1.5 m and 4.35 m, inclusive; between approximately 1.5 m and 6 m, inclusive; between approximately 4.35 m and 6 m, inclusive; between approximately 1.25 m and 6.5 m, inclusive; between approximately 1.5 m and 5 m, inclusive; and between approximately 10 m and 15 m, inclusive.

The yarn 100 (as well as the inner material 18) may have a cross-dimension (such as, but not limited to, a diameter) between approximately 1.5 centimeters (cm) and 20 cm, inclusive; such as between approximately 1.5 cm and 15 cm, inclusive; between approximately 1.5 cm and 12 cm, inclusive; between approximately 1.7 cm and 2.3 cm (e.g., 2 cm), inclusive; between approximately 3.5 cm and 4.5 cm (e.g., 4 cm), inclusive; between approximately 5 cm and 6 cm (e.g., 5.5 cm), inclusive; between approximately 2 cm and 5.5 cm, inclusive; between approximately 2 cm and 4 cm, inclusive; between approximately 4 cm and 5.5 cm, inclusive; between approximately 1 cm and 3 cm, inclusive; between approximately 4.5 cm and 6.5 cm, inclusive; between approximately 8 cm and 13 cm, inclusive; between approximately 10 cm and 12 cm, inclusive; between approximately 12 cm and 20 cm, inclusive; and between approximately 15 cm and 20 cm, inclusive.

In some embodiments, the yarn 100 may have a linear density (i.e., weight per unit length) between approximately 136 g/m and 181 g/m (e.g., 150 g/m), inclusive; between approximately 91 g/m and 136 g/m (e.g., 104 g/m), inclusive; and between approximately 204 g/m and 249 g/m (e.g., 227 g/m), inclusive. In other embodiments, the yarn 100 may have a linear density between approximately 25 g/m and 300 g/m, inclusive, such as between approximately 35 g/m and 250 g/m, inclusive; between approximately 30 g/m and 60 g/m, inclusive; between approximately 30 g/m and 50 g/m, inclusive; between approximately 30 g/m and 45 g/m, inclusive; between approximately 75 g/m and 125 g/m, inclusive; between approximately 80 g/m and 115 g/m, inclusive; between approximately 80 g/m and 105 g/m, inclusive; between approximately 90 g/m and 110 g/m, inclusive; between approximately 200 g/m and 275 g/m, inclusive; between approximately 215 g/m and 265 g/m, inclusive; between approximately 225 g/m and 260 g/m, inclusive; between approximately 215 g/m and 235 g/m, inclusive; between approximately 225 g/m and 245 g/m, inclusive; and between approximately 240 g/m and 260 g/m, inclusive.

In some embodiments, the yarn 100 has a volumetric density between approximately 40 kg/m³ and 220 kg/m³, inclusive; between approximately 50 kg/m³ and 210 kg/m³, inclusive; between approximately 50 kg/m³ and 110 kg/m³, inclusive; between approximately 70 kg/m³ and 140 kg/m³, inclusive; and between approximately 80 kg/m³ and 220 kg/m³, inclusive.

### Pillow 200

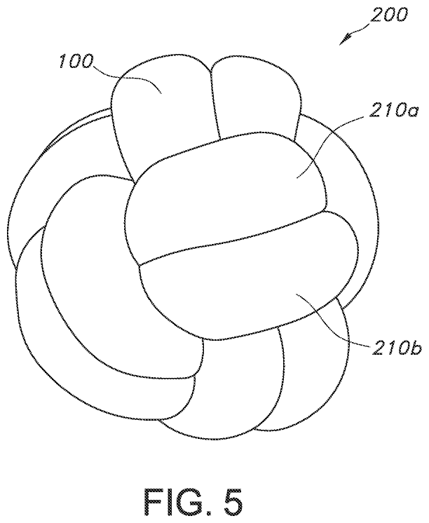

Embodiments of the yarn 100 may be used to form resilient pillows 200 of any shape or size. In some embodiment, the yarn 100 is interlooped in accordance with a knotting pattern and tightened to form a pillow 200. A single continuous yarn 100 may be used to form a pillow 200 or multiple discrete yarns 100 may form a pillow 200. Regardless, the knotting pattern may be repeated depending on the desired number of loops. For example, FIG. 1 illustrates a pillow 200 with three loops 210a, 210b, 210c whereas FIG. 5 illustrates a pillow 200 with two loops 210a, 210b.

In FIG. 1, the yarn 100 is illustrated forming a substantially spherical shaped resilient pillow 200, which, for example, can have an approximate diameter of between approximately 3.5 inches (in.) and 4.5 in. (e.g., 4 in.), inclusive; between approximately 8.5 in. and 9.5 in. (e.g., 9 in.), inclusive; between approximately 10.5 in. and 11.5 in. (e.g., 11 in.), inclusive; between approximately 4 in. and 9 in., inclusive; between approximately 4 in. and 11 in., inclusive; and between approximately 9 in. and 11 in., inclusive. In some embodiments, the pillow 200 can have a diameter as low as approximately 2 inches up to approximately 18 inches, depending on the desired use of the pillow. The yarn 100 may form pillows of any size and of any shape, including, but not limited to, pillows that have a substantially square shape, rectangular shape, triangular shape, pyramidal shape, ovular shape, circular shape, rose shape, flower shape, star shape, donut shape, etc.

In some embodiments, the resilient pillows 200 may weigh between approximately 0.1 lb. and 0.2 lb., inclusive; between approximately 0.25 lb. and 0.75 lb., inclusive (e.g., 0.5 lb.), between approximately 0.8 lb. and 1 lb., inclusive; between approximately 0.5 lb. and 1.5 lbs., inclusive (e.g., 1 lb.), between approximately 2.5 lbs. and 3.5 lbs., inclusive (e.g., 3 lbs.), between approximately 2.9 lbs. and 3.3 lbs., inclusive; between approximately 0.5 lb. and 1 lb., inclusive; between approximately 0.5 lb. and 3 lbs., inclusive; between approximately 1 lb. and 3 lbs., inclusive; and between approximately 0.025 lb. and 3.5 lbs. inclusive. In some embodiments, the resilient pillows 200 are heavier, weighing up to and including 10 lbs., such as between approximately 4 lbs. and 10 lbs., inclusive; between approximately 5 lbs. and 10 lbs., inclusive; between approximately 6 lbs. and 10 lbs., inclusive; between approximately 7 lbs. and 10 lbs., inclusive; between approximately 8 lbs. and 10 lbs., inclusive; and between approximately 9 lbs. and 10 lbs., inclusive.

In some embodiments, a pillow 200 has a pillow diameter between 3 in. and 5 in. (inclusive) and a pillow weight between 0.1 lb. and 1 lb. (inclusive) and is formed of a yarn having a yarn length between 140 cm and 160 cm (inclusive), a yarn diameter between 1.5 cm and 2.3 cm (inclusive), a yarn linear density between 30 g/m and 50 g/m (inclusive) and a yarn volumetric density between 80 kg/m³ and 220 kg/m³ (inclusive). In some embodiments, a pillow 200 has a pillow diameter between 8 in. and 10 in. (inclusive) and a pillow weight between 0.5 lb. and 1.5 lb. (inclusive) and is formed of a yarn having a yarn length between 400 cm and 475 cm (inclusive), a yarn diameter between 3.5 cm and 4.5 cm (inclusive), a yarn linear density between 75 g/m and 110 g/m (inclusive) and a yarn volumetric density between 50 kg/m³ and 110 kg/m³ (inclusive). In some embodiments, a pillow 200 has a pillow diameter between 10 in. and 12 in. (inclusive) and a pillow weight between 2 lb. and 4 lb. (inclusive) and is formed of a yarn having a yarn length between 550 cm and 650 cm (inclusive), a yarn diameter between 5.0 cm and 6.0 cm (inclusive), a yarn linear density between 215 g/m and 265 g/m (inclusive); and a yarn volumetric density between 70 kg/m³ and 140 kg/m³ (inclusive). These are merely exemplary combinations of the various properties of the yarn and pillows disclosed herein. The various properties disclosed here may be combined in any combination to result in the desired pillow.

In some embodiments, these weights are sufficient to achieve therapeutic benefits to the user if desired. Resilient pillows 200 according to embodiments of the invention may be used for a variety of therapeutic purposes. The interlooping of the yarn 100 creates heavy knots at the cross-sections of the loops. This pattern of heavy knots, in turn, creates a pattern of pressure regions on the individual when the resilient pillow 200 is placed on them, rolled over them, squeezed by them, etc. This provides a highly effective deep pressure therapy to the user and may provide useful pressure points when the resilient pillow 200 is used to massage the user.

Moreover, pillows formed with yarns 100 having an elastic inner material 18 (e.g., foam tube 20) may be used as a stress ball to relieve anxiety and/or tension. The resilient pillow 200 absorbs energy when it is deformed elastically due to an applied pressure, e.g., when squeezed, pressed, hugged, sat on, etc. by a user, and releases that energy upon release of the pressure applied by the user to return the resilient pillow 200 to its original, equilibrium (i.e., non-deformed) state. In this way, the resilient pillow 200 is resilient and bounces back after a pressure is applied by a user.

While this disclosure describes using the resilient pillow 200 to provide deep pressure therapy and therapeutic sensory and stress relief, it should be well understood that the resilient pillow 200 may be used for other purposes, in addition to or as an alternate to deep pressure therapy and therapeutic sensory and stress relief. Further, while this disclosure describes using the resilient pillow 200 for a person, it should be well understood that the resilient pillow 200 may be used with other suitable kinds of animals to provide them with deep pressure therapy and therapeutic sensory and stress relief. Finally, while embodiments of the yarn 100 are described for use in forming pillows 200, they may be incorporated into a variety of other therapeutic objects and devices.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

I claim:

1. A pillow formed of interlooped yarn, wherein the interlooped yarn comprises an outer tube that encases a resilient inner material that (i) comprises an equilibrium free-standing shape and (ii) is compressible and configured to return to the equilibrium free-standing shape after compression.

2. The pillow of claim 1, wherein the outer tube is formed of a woven or knitted fabric.

3. The pillow of claim 2, wherein the fabric weighs between approximately 60 g/m² and 240 g/m², inclusive.

4. The pillow of claim 1, wherein the resilient inner material comprises a foam.

5. The pillow of claim 1, wherein the resilient inner material comprises rubber.

6. The pillow of claim 1, wherein the resilient inner material comprises a gel.

7. The pillow of claim 1, wherein the resilient inner material comprises a density between approximately 40 kg/m³ to 160 kg/m³, inclusive.

8. The pillow of claim 1, wherein the outer tube defines a conduit having a volume and wherein the resilient inner material fills substantially 100% of the volume.

9. The pillow of claim 1, wherein the yarn has a cross-dimension between approximately 1.7 centimeters and 6 centimeters, inclusive.

10. The pillow of claim 1, wherein the yarn has a substantially circular cross-sectional shape.

11. The pillow of claim 1, wherein the yarn comprises a density between approximately 50 kg/m³ and 210 kg/m³, inclusive.

12. The pillow of claim 1, wherein the yarn comprises a cross-sectional shape and the resilient inner material comprises a cross-sectional shape that is substantially the same as the cross-sectional shape of the yarn.

13. The pillow of claim 1, wherein the pillow comprises a cross-dimension between approximately 3.5 inches and 11.5 inches, inclusive.

14. The pillow of claim 1, wherein the pillow comprises a substantially spherical shape.

15. The pillow of claim 1, wherein the pillow is formed of a single interlooped yarn.

16. The pillow of claim 1, wherein the pillow is formed of a plurality of interlooped yarns.

17. The pillow of claim 1, wherein the pillow weighs between approximately 0.25 pounds and 3.3 pounds, inclusive.

18. A pillow formed of interlooped yarn, wherein the interlooped yarn comprises an outer tube formed of a woven or knitted fabric that encases a resilient foam material that (i) comprises an equilibrium free-standing shape and (ii) is compressible and configured to return to the equilibrium free-standing shape after compression, wherein:
(i) the outer tube defines a conduit having a volume and wherein the resilient foam material fills substantially 100% of the volume;
(ii) the yarn has a substantially circular cross-sectional shape with a diameter between approximately 1.7 centimeters and 6 centimeters, inclusive; and
(iii) the pillow weighs between approximately 0.25 pounds and 3.3 pounds, inclusive.

19. The pillow of claim 18, wherein the pillow comprises a substantially spherical shape, has a diameter between approximately 3.5 inches and 4.5 inches, inclusive, and weighs between approximately 0.25 pounds and 0.75 pounds, inclusive.

20. The pillow of claim 18, wherein the pillow comprises a substantially spherical shape, has a diameter between approximately 8.5 inches and 9.5 inches, inclusive, and weighs between approximately 0.50 pounds and 1.5 pounds, inclusive.

21. The pillow of claim 18, wherein the pillow comprises a substantially spherical shape, has a diameter between approximately 10.5 inches and 11.5 inches, inclusive, and weighs between approximately 2.5 pounds and 3.5 pounds, inclusive.
